(19) United States
(12) Patent Application Publication
(10) Pub. No.: US 2025/0279602 A1
(43) Pub. Date: Sep. 4, 2025

(54) HIGH-SPEED BOARD-TO-BOARD CONNECTOR ASSEMBLY WITH INTEGRATED MATE ASSURANCE

(71) Applicant: Molex, LLC, Lisle, IL (US)

(72) Inventors: Tommy Lawrence, Little Rock, AR (US); Bratislav Kostic, Chicago, IL (US); Robert Dillman, Santa Clara, CA (US)

(21) Appl. No.: 19/038,731

(22) Filed: Jan. 28, 2025

Related U.S. Application Data
(60) Provisional application No. 63/559,220, filed on Feb. 29, 2024.

(51) Int. Cl. H01R 12/75; H01R 12/70; H01R 13/04; H01R 13/11; H01R 13/502

(52) U.S. Cl. CPC H01R 12/75; H01R 12/7011; H01R 13/04; H01R 13/11; H01R 13/502

(57) ABSTRACT

A high-speed blind-mate board-to-board cable assembly includes a housing with cabling stored therein, configured to be positioned between two substrates. The housing comprises pin receptacle portions for receiving pins from one substrate. The assembly also includes a first socket and a second socket, each equipped with at least one spring plunger, allowing vertical movement to accommodate variable distances between the substrates. The housing also includes floats permitting horizontal movement of the pins. The sockets are configured to couple the cabling to the respective substrates. The assembly provides a high-performance cable connection between two stacked substrates (e.g., printed circuit boards), providing full mate assurance and minimizing risk of performance degradation.

### TECHNICAL FIELD

The present disclosure generally relates to the field of electronic interconnect technology and, more specifically, to systems, methods, and connector devices that ensure reliable, high-speed, board-to-board cable connections with integrated full mate assurance.

### BACKGROUND

Electronic interconnect technology is a field that encompasses the design and implementation of various types of connectors and cables used to establish connections between electronic components. One common application of this technology is in the creation of board-to-board cable assemblies, which are used to establish connections between two printed circuit boards (PCBs) or similar substrates. These assemblies often employ a variety of connectors and cables to facilitate the transmission of signals across the PCBs. In many applications, these connections are expected to support high-speed data transmissions, making the design and implementation of these assemblies a complex task. Furthermore, the connectors used in these assemblies often have to be designed to ensure a reliable connection, even in scenarios where the alignment of the connector components cannot be visually confirmed, such as in blind-mate scenarios.

### SUMMARY

According to an aspect of the present disclosure, a system includes a first substrate, a second substrate having a first pin and a second pin, and a connector assembly configured to couple the first substrate to the second substrate. The connector assembly includes a housing having a first connector housing portion and a second connector housing portion adapted to detachably attach to one another and retain cabling therein. The first connector housing portion and the second connector housing portion each include a pin receptacle portion configured to receive the first pin and the second pin, respectively. The connector assembly also includes a first socket configured to couple the cabling to the first substrate, and a second socket configured to couple the cabling to the second substrate. The first socket and the second socket include at least one spring plunger that permits movement in a vertical direction.

According to other aspects of the present disclosure, the system may include a first cap and a first cap base configured to receive a distal end of the first pin and connect the first pin to the first substrate, where the first cap has a float that permits movement in a horizontal direction. The system may also include a second cap and a second cap base configured to receive a distal end of the second pin and connect the second pin to the first substrate, where the second cap has a float that permits movement in a horizontal direction. The first pin may be a first screw-mount pin forming a threaded connection with the second substrate, and the second pin may be a second screw-mount pin forming a threaded connection with the second substrate.

According to another aspect of the present disclosure, a board-to-board connector assembly includes a housing having cabling stored therein, the housing configured to be positioned between a first substrate and a second substrate. The assembly also includes a first socket configured to couple the cabling to the first substrate, and a second socket configured to couple the cabling to the second substrate. The first socket and the second socket each include at least one spring plunger that permits movement in a vertical direction to accommodate variable distances between the first substrate and the second substrate.

According to other aspects of the present disclosure, the housing may include a first connector housing portion and a second connector housing portion detachably attachable to one another. The first connector housing portion and the second connector housing portion each may include a pin receptacle portion configured to receive a first pin coupled to the second substrate and a second pin coupled to the second substrate, respectively.

According to yet another aspect of the present disclosure, a method for coupling substrates includes providing a bottom substrate comprising a plurality of pins oriented in a vertical direction and a bottom substrate socket. The method also includes providing a board-to-board connector assembly. The board-to-board connector assembly comprises a housing having cabling stored therein, a first socket, and a second socket. The housing includes a plurality of pin receptacle portions, and the first socket and the second socket each include at least one spring plunger that permits movement in a vertical direction to accommodate variable distances between the first substrate and the second substrate. The method further includes positioning the pins in the pin receptacle portions of the housing, wherein the housing comprises a plurality of floats that permit the plurality of pins to move in a horizontal direction; coupling the first socket of the board-to-board connector assembly to the bottom substrate socket of the bottom substrate; and positioning a top substrate on top of the housing to couple the second socket of the board-to-board connector assembly to a top substrate socket of the top substrate.

The foregoing general description of the illustrative embodiments and the following detailed description thereof are merely exemplary aspects of the teachings of this disclosure and are not restrictive.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a top perspective view of a connector assembly forming a connection between substrates in accordance with various embodiments of the present disclosure.

FIG. 2 is another top perspective view of the connector assembly of FIG. 1 in accordance with various embodiments of the present disclosure.

FIG. 3 is a bottom perspective view of the connector assembly of FIG. 1 forming a connection between substrates in accordance with various embodiments of the present disclosure.

FIG. 4 is another bottom perspective view of the connector assembly of FIG. 3 in accordance with various embodiments of the present disclosure.

FIG. 5 is a top perspective view of the connector assembly of FIG. 1 with a housing thereof omitted in accordance with various embodiments of the present disclosure.

FIG. 6 is a bottom perspective view of the connector assembly of FIG. 1 with the housing thereof omitted in accordance with various embodiments of the present disclosure.

FIG. 7 is another bottom perspective view of the connector assembly of FIG. 1 with a portion of the housing thereof omitted in accordance with various embodiments of the present disclosure.

FIG. 8 is a top perspective view of a connector assembly forming a connection between substrates in accordance with various embodiments of the present disclosure.

FIG. 9 is another top perspective view of the connector assembly of FIG. 8 in accordance with various embodiments of the present disclosure.

FIG. 10 is a top perspective view of the connector assembly of FIG. 8 coupling two substrates with a portion of a housing thereof omitted in accordance with various embodiments of the present disclosure.

FIG. 11 is another top perspective view of the connector assembly of FIG. 8 with a housing thereof omitted in accordance with various embodiments of the present disclosure.

### DETAILED DESCRIPTION

The present disclosure relates to a board-to-board connector that provides a high-performance cable connection between two stacked substrates. In the field of electronic connectors, board-to-board connectors are commonly used to provide electrical connections between two printed circuit boards (PCBs). These connectors are designed to facilitate the transmission of signals and/or power between the PCBs. The connectors can be configured in various configurations, such as edge-to-edge, right angle, or stacked, depending on the specific requirements of the application. High-speed data transmission is a desirable feature in many modern electronic devices and systems. As such, board-to-board connectors that can support high-speed data transmission are increasingly in demand. These connectors are typically designed to minimize signal loss and crosstalk, which can degrade the quality of transmitted data.

Blind-mate connectors are a type of board-to-board connector that allows for the connection of PCBs without the ability to visually confirm the alignment of the connector components. Thus, blind-mate connectors can be particularly useful in applications where space constraints or other factors make it difficult to visually inspect the connection process. These connectors typically incorporate design features that allow for some degree of misalignment between the connector components, while still ensuring a reliable electrical connection.

Existing board-to-board connectors generally use a screw arrangement in order to permit adjustment in a vertical direction, for instance, to control a distance between two PCBs. A screw couples a first substrate, a connector, and a second assembly. To tighten the connection between the first substrate and the second substrate, the screw can be turned in a first direction, whereas, to loosen the connection between the first substrate and the second substrate, the screw can be turned in a second, opposite direction. As can be appreciated, over-tightening the screw can result in damage to the first substrate, the second substrate, and/or the connector. Also, the screw does not account for desirable tolerances in the X and Z direction.

Accordingly, various embodiments are described herein for a high-speed blind-mate board-to-board connector assembly. The connector assembly includes a housing with cabling stored therein that is configured to be positioned between two PCBs or other substrates. The housing can include pin receptacle portions for receiving pins from a substrate. The connector assembly can further includes a first socket and a second socket, each equipped with at least one spring plunger, allowing vertical movement to accommodate variable distances between the substrates. The housing also includes floats permitting horizontal movement of the pins. The assembly provides a high-performance cable connection between two stacked substrates, providing full mate assurance and minimizing risk of performance degradation.

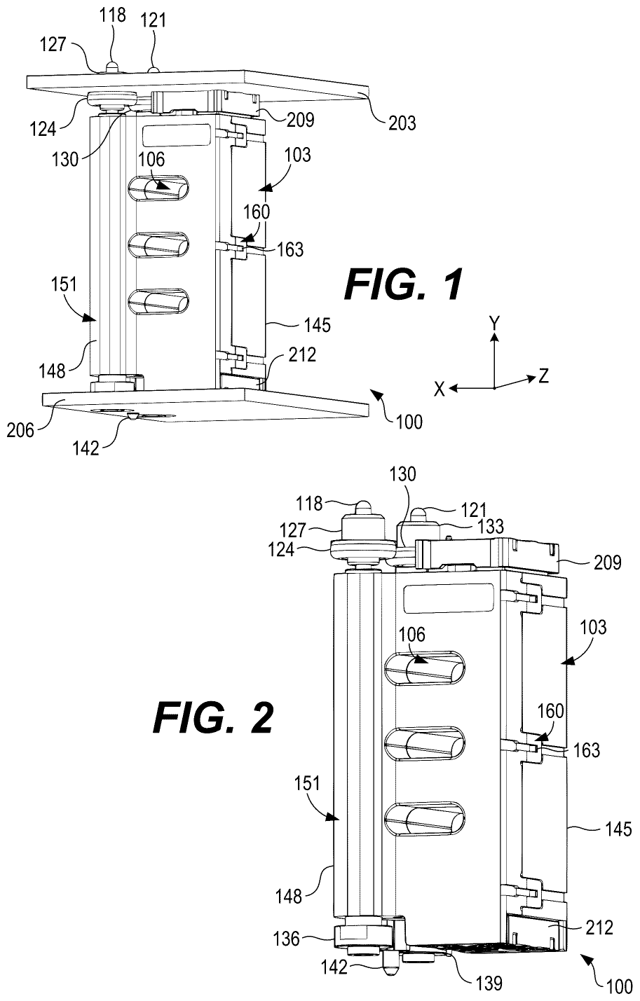

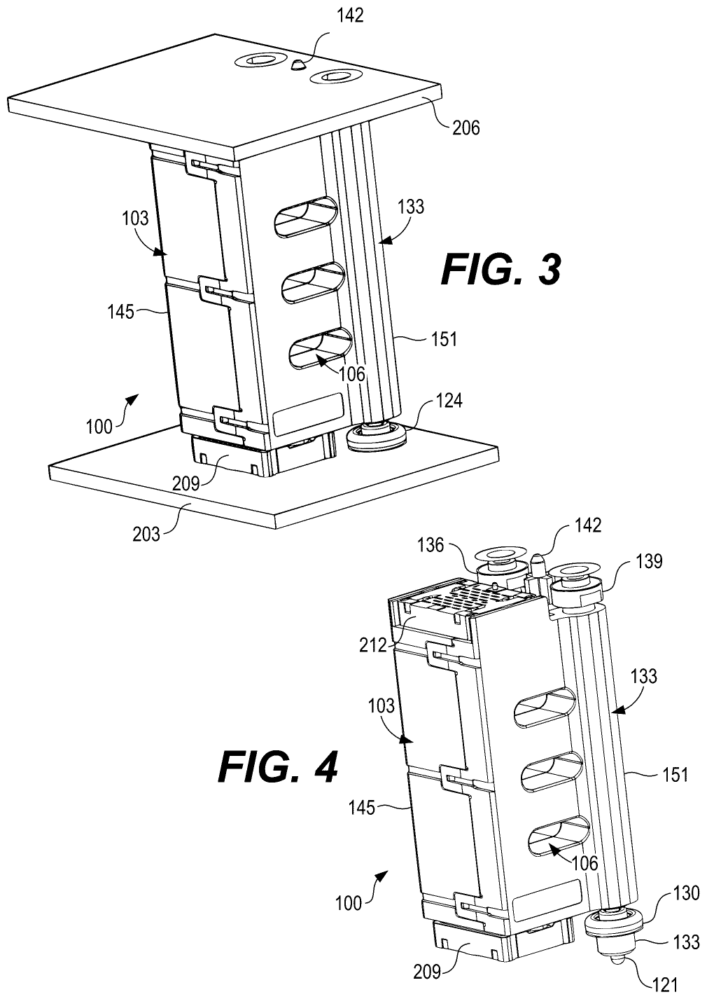

Turning now to the drawings, FIGS. 1 and 2 illustrate top perspective views of a connector assembly 100 from the same angle. FIG. 1, however, depicts an example of the connector assembly 100 coupled to substrates 203, 206, whereas FIG. 2 omits the substrates 203, 206 for explanatory purposes. FIGS. 3 and 4 likewise illustrate bottom perspective views of the connector assembly 100 also from the same angle, where FIG. 3 includes the substrates 203, 206 and FIG. 4 omits the substrates 203, 206 for explanatory purposes.

Referring to FIGS. 1-4 collectively, the connector assembly 100 is an example connector for coupling a first substrate 203 (e.g., a first PCB) to a second substrate 206 (e.g., a second PCB). Thus, the connector assembly 100 can be referred to as a mezzanine or board-to-board connector. However, in alternative implementations, the connector assembly 100 can be a board-to-cable connector, cable-to-cable connector, busbar-to-busbar, busbar-to-board, board-to-busbar, or other connector featuring the various components described herein.

Generally, the connector assembly 100 includes a connector housing 103 where, in some implementations, the housing 103 includes a multitude of housing apertures 106 that extend through an entirety of the housing 103, permitting airflow from a side of the housing 103 to the other.

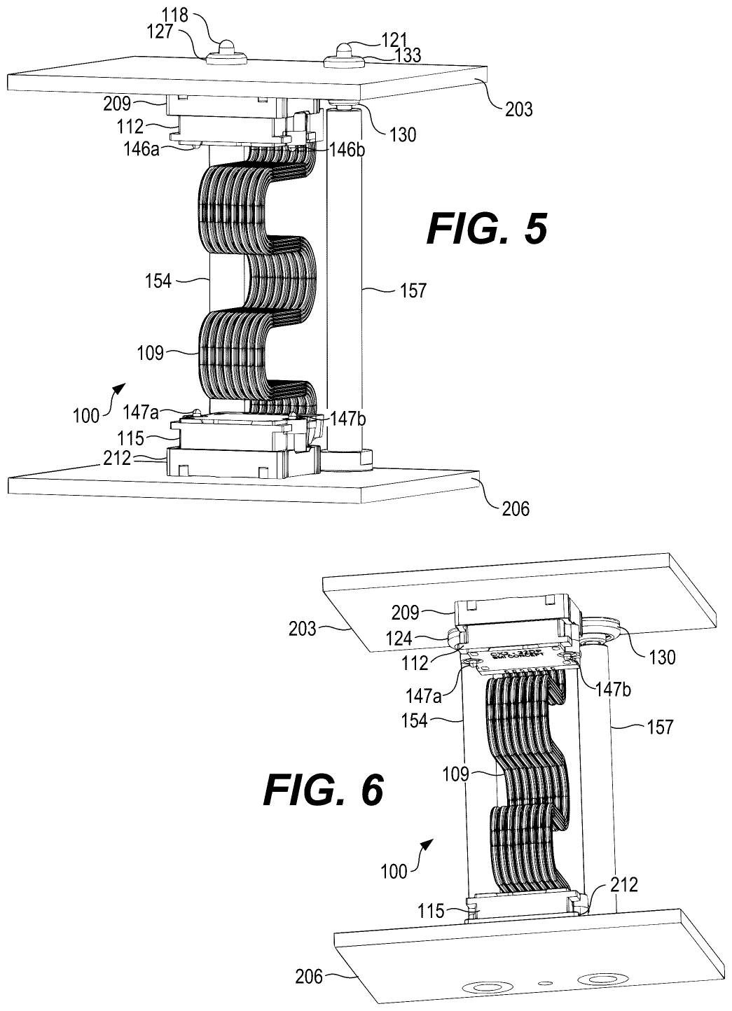

For explanatory purposes, the housing 103 of the connector assembly 100 is omitted in FIGS. 5 and 6, thereby exposing components of the connector assembly 100 partially or wholly internal to the housing 103. Referring collectively to FIGS. 1-6, the connector assembly 100 can further include cabling 109 and one or more sockets coupled to ends of the cabling 109. The cabling 109 can include, for example, one or more ribbon cables, although the disclosure is not so limited.

The housing 103 of the connector assembly 100 can be formed of a non-conductive material, such as a non-conductive polymer material able to be formed from a variety of plastics that offer varying insulation properties, mechanical strength, and thermal stability. The housing 103 thus can be formed of a plastic or polymer, such as liquid crystal polymer (LCP), polyethylene (PE), polytetrafluoroethylene (PTFE), fluoropolymer, polycarbonate (PC), acrylonitrile butadiene styrene (ABS), polyphenylene oxide (PPO), polybutylene terephthalate (PBT), polyethylene terephthalate (PET), thermoplastic polyurethane (TPU), any combination thereof, as well as other polymer materials. The polymer material can be selected based on specific operating requirements of the connector assembly 100, such as the operating temperature range, mechanical stress, and so forth.

The sockets can be configured to couple the cabling 109 to the substrates 203, 206. For instance, in some embodiments, the sockets can include a first blind-mate interface (BMI) socket 112 and a second blind-mate interface socket 115. Each of the blind-mate interface sockets 112, 115 can include a multitude of terminals for power, signal, and/or data communication, where the terminals are configured to contact terminals or pads on a corresponding socket. For example, the terminals of the blind-mate interface sockets 112, 115 can be selected to establish a reliable electrical connection between the connector assembly 100 and the corresponding substrate sockets 209, 212 on the substrates 203, 206 without the need for direct visual alignment. In some implementations, the terminals can be configured to accommodate a degree of lateral (X-Z axis) and vertical (Y-axis) misalignment, which can be useful in blind-mate scenarios where the connector assembly 100 cannot be visually guided into place.

The blind-mate interface sockets 112, 115 can be wholly or partially recessed within the housing 103, as shown in FIGS. 1-6. However, in some embodiments, the blind-mate interface sockets 112, 115 can be external to the housing 103. The blind-mate interface sockets 112, 115 can form connections with corresponding substrate sockets 209, 212, respectively, such that the first substrate 203 (e.g., a first PCB) is electrically coupled to the second substrate 206 (e.g., a second PCB) via the connector assembly 100 for data communication. While various embodiments describe two blind-mate interface sockets 112, 115, the disclosure is not so limited, and a differing number of sockets and a differing type of sockets can be employed.

The connector assembly 100 can further include one or more pins for power transfer between substrates 203, 206, such as a first screw-mount pin 118 and a second screw-mount pin 121. The first screw-mount pin 118 and the second screw-mount pin 121 can extend substantially along a height of the connector assembly 100. While various embodiments described herein show the first screw-mount pin 118 and the second screw-mount pin 121 as part of the connector assembly 100, it is understood that, in some embodiments, the first screw-mount pin 118 and the second screw-mount pin 121 are preexisting. For instance, the first screw-mount pin 118 and the second screw-mount pin 121 may be part of an existing system of the second substrate 206, for example. To this end, the connector assembly 100 can be configured to be positioned on the first screw-mount pin 118 and the second screw-mount pin 121 such that they are able to be received by and coupled to the connector assembly 100, and further coupled to the first substrate 203.

A first distal end of the first screw-mount pin 118 can be received in a first cap base 124 and a first cap 127. Similarly, a first distal end of the second screw-mount pin 121 can be received in a second cap base 130 and a second cap 133. The first cap base 124, the first cap 127, the second cap base 130, and the second cap 133 can couple the first distal ends of the screw-mount pins 118, 121 to the first substrate 203, as shown in FIG. 1. Further, the first cap base 124, the first cap 127, the second cap base 130, and the second cap 133 can include floats permitting movement along the X axis (e.g., a horizontal direction), facilitating easy alignment of the connector assembly 100 to the substrates 203, 206 or sockets 209, 212 thereof.

A second distal end of the first screw-mount pin 118 can form a connection with the second substrate 206 via a first threaded connector 136. Likewise, a second distal end of the second screw-mount pin 121 can form a connection with the second substrate 206 via a second threaded connector 139. The first threaded connector 136 and/or the second threaded connector 139 can include a nut, bolt, or like device that can couple the respective screw-mount pins 118, 121 to the second substrate 206. The screw-mount pins 118, 121 can be formed of a conductive material, such as copper, steel, gold, silver, any combination thereof, or other suitable conductive material. While various embodiments show the pins as being screw-mount pins 121, it is understood that other types of pins can be employed.

Further, a bottom end of the connector assembly 100 can include a projection 142 configured to project into an aperture of the second substrate 206. The projection 142 can be formed of a non-conductive, polymer material in some embodiments. The projection 142 can further secure the housing 103 of the connector assembly 100 to the second substrate 206, as can be appreciated.

The housing apertures 106 may facilitate heat transfer and cooling, and the cabling 109 can be positioned around the housing apertures 106 to facilitate cable management and heat transfer, as will be described. The connector housing 103 may be formed of a multitude of connector housing portions in some embodiments. For instance, in some embodiments, the connector housing 103 includes a first connector housing portion 145 and a second connector housing portion 148 configured to detachably attach to one another. In some embodiments, the projection 142 can be integral with the housing 103. More specifically, in some embodiments, the projection 142 can be integral with the first connector housing portion 145 of the housing 103.

The first connector housing portion 145 and the second connector housing portion 148 can each include a pin receptacle portion 151, which can be sized and positioned to receive and retain respective screw-mount pins 118, 121 therein. For instance, the first screw-mount pin 118 and the second screw-mount pin 121 can be contained within a first pin housing 154 and a second pin housing 157, respectively, where the pin housings 154, 157 can have a circular or ovular cross-section in various embodiments. The pin receptacle portion 151 can thus have a circular or ovular cross-section sized and dimensioned to retain the pin housings 154, 157 in an interference arrangement.

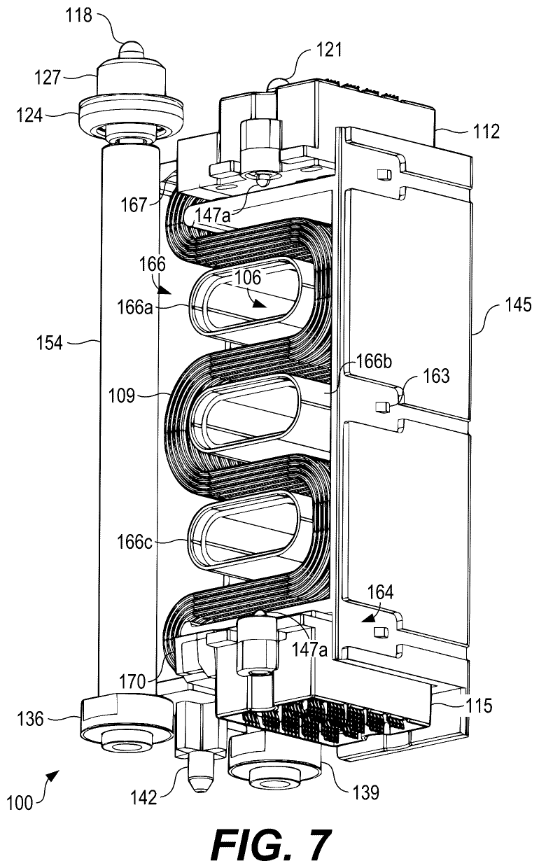

The second connector housing portion 148 can include one or more tabs 160 (or protruding portions) that engage with corresponding features on the first connector housing portion 145. For instance, the tabs 160 can include apertures that couple to projections 163 integral with the first connector housing portion 145 such that a snap connection can be formed between first connector housing portion 145 and the second connector housing portion 148. The snap connection may facilitate access to internal components of the connector assembly 100, for instance, to adjust the cabling 109. The tabs 160 can also be positioned within tab recesses 164 defined on a surface of the housing 103, best shown in FIG. 7. The tab recesses 164 can include an edge similarly sized and positioned relative to the tabs 160 such that the tabs 160 can be recessed in the tab recesses 164. The edges of the tab recesses 164 provide an interference connection to facilitate a tight connection between the first connector housing portion 145 and the second connector housing portion 148.

Turning back to FIGS. 5 and 6, the first blind-mate interface socket 112 may include spring plungers 146a, 146b, whereas the second blind-mate interface socket 115 can include spring plungers 147a, 147b. The spring plungers 146a, 146b, 147a, 147b can include press-fit spring plungers in some embodiments that enable movement along the Y axis (e.g., a vertical direction) and facilitate blind mating contact, as can be appreciated. The spring plungers 146a, 146b, 147a, 147b ensure a reliable connection between the first substrate 203 and the second substrate 206, accommodating for any misalignments or tolerances between the two while also providing the ability to use the connector assembly 100 in situations in which the substrates 203, 206 have a variable distance with respect to one another.

The plungers 146a, 146b, 147a, 147b can be part of a spring-loaded terminal which can further include a barrel and a spring. The spring can provide a constant force against a respective plunger, ensuring that it maintains contact with a socket substrate 209, 212 even when there are variations in the distance between the connector assembly 100 and the substrate 203, 206 due to manufacturing tolerances or thermal expansion. As the connector assembly 100 is brought into proximity with a substrate socket 209, 212, the terminals may include features, such as chamfered edges or lead-in designs, that help guide the terminals into a proper connection with the corresponding pads or terminals on the substrate 203, 206.

Once aligned, the terminals make electrical contact with corresponding pads or terminals on the substrate socket. This contact allows for the transmission of power, signals, and/or data between the substrates 203, 206. The plungers within the sockets 112, 115 can provide a retention force that maintains the electrical connection over time, compensating for vibrations, shocks, or thermal cycling that might otherwise disrupt the connection. The combination of these features can allow the blind-mate interface sockets 112, 115 to be used in environments where direct visual alignment is not possible, while still ensuring a secure and reliable electrical connection.

In some cases, the X-Y float integrated into the connector assembly 100 provides a smooth alignment between the substrates 203, 206 and the cables of the connector assembly 100. In some implementations, cable housings can be loaded into an over-mate condition via the spring plungers 146a, 146b, 147a, 147b (or, alternatively, using traditional compression springs) to ensure that both ends of the cabling 109 are always in a full-mate condition throughout a tolerance range of a system.

Moving along to FIG. 7, a perspective view of the connector assembly 100 is shown where the substrates 203, 206, the substrate sockets 209, 212, and the second connector housing portion 148 are omitted for explanatory purposes. As shown in FIG. 7, the cabling 109 can be snaked, threaded, or otherwise positioned around one or more cabling projections 166a . . . 166c (collectively “cabling projections 166”) positioned within the housing 103. For instance, the cabling projections 166 can include walls extending from one or both of the first connector housing portion 145 and/or the second connector housing portion 148, where the walls define the apertures 106 of the housing 103. In some embodiments, the cabling projections 166 can be ovular, as shown in FIG. 7, and can mate with corresponding cabling projections (not shown) positioned on the second connector housing portion 148. However, it is understood that the cabling projections 166 can assume other desirable shapes depending on the desired arrangement of the cabling 109.

The cabling 109 can make contact with the cabling projections 166 such that a predetermined shape or arrangement of the cabling 109 is maintained. For instance, the positioning of the cabling 109 around the three cabling projections 166 shown in FIG. 7 creates multiple S-shaped sections in the cabling 106. The S-shaped sections in the cabling 106 improve signal integrity such that any overlaps in the cabling 106 do not create magnetic interference. For instance, the housing 103 contains and protects the cables within a column of space between two substrates 203, 206 where risk of performance degradation due to damage during customer handling is minimized and overall space requirements are optimized for the connector assembly 100. Moreover, the apertures 106 facilitate heat transfer. For instance, as air travels through the apertures 106, the air absorbs any heat emitted by the cabling 106 and/or the overall connector assembly 100.

Accordingly, various embodiments for a connector assembly 100 are described that enable a high-performance cable connection between two substrates 203, 206, such as two stacked PCBs. The connector assembly 100 utilizes a blind-mate floating cable housing with spring-loaded, screw-mount pins 118, 121 that provide full mate assurance. The connector assembly 100 accounts for dimensional tolerances between substrates 203, 206 and/or substrate sockets 209, 212.

In some embodiments, the first blind-mate interface socket 112 and the second blind-mate interface socket 115 can be coupled to one or more stress-relief couplers, such as a first stress-relief coupler 167 and a second stress-relief coupler 170. The stress-relief couplers 167, 170 provide increased rigidity and stress relief at the junction of the cabling 109 and the blind-mate interface sockets 112, 115, and the stress-relief couplers 167, 170 can be formed of a polymer material through an overmold process in some embodiments.

Further, in various embodiments, the connector assembly 100 can be mated vertically to a PCB connector of a second substrate 206, where the connector assembly 100 can be roughly aligned via power pins. Then, a second substrate 206 (e.g., an upper PCB) can be mated vertically to the connector assembly 100. An X-Y float integrated into the connector assembly 100 allows for smooth alignment between PCB connectors and the cables. The cable housings are also loaded into an over-mate condition via screw-mount pins (or other compression means, such as springs) to ensure that both ends of a cable are maintained in a full-mate condition throughout a tolerance range of an overall system.

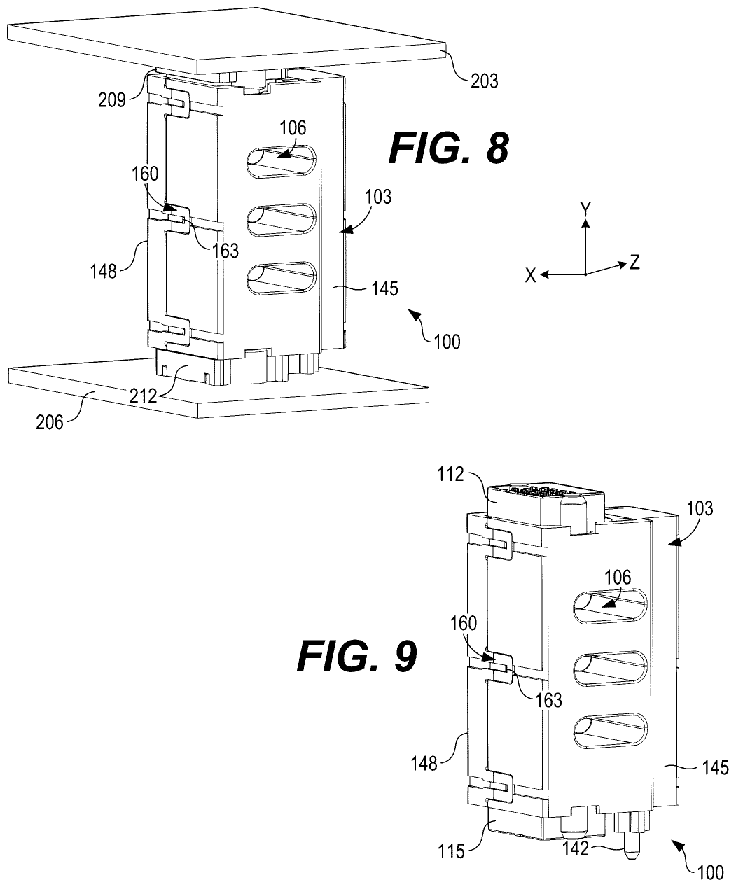

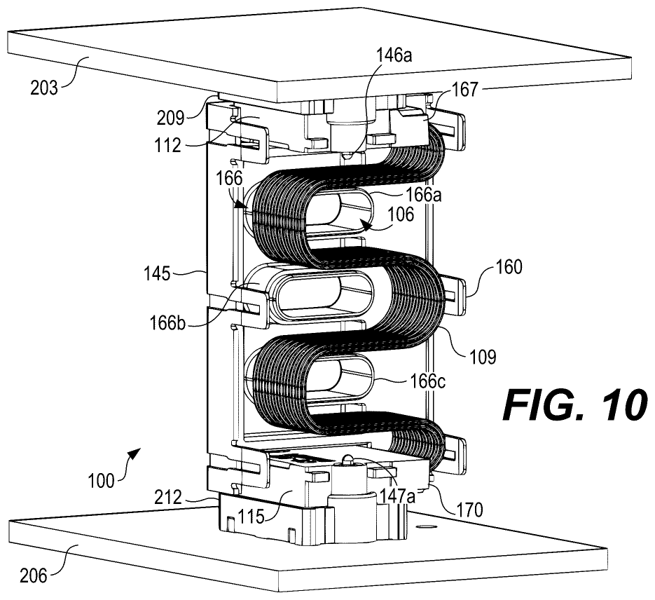

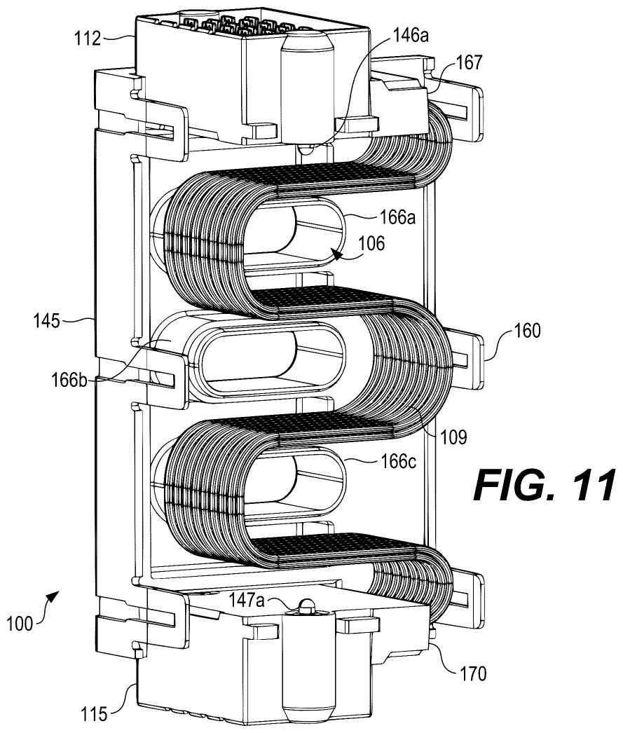

Moving along, FIG. 8 shows a top perspective view of another embodiment of a connector assembly 100 according to the present disclosure, and FIG. 9 illustrates the connector assembly 100 of FIG. 8 with the first substrate 203 and the second substrate 206 omitted for explanatory purposes. FIG. 10 shows the connector assembly 100 of FIG. 8 with the second connector housing portion 148 omitted, and FIG. 11 shows the connector assembly 100 of FIG. 8 with the second connector housing portion 148, the first substrate 203, and the second substrate 206 omitted, again for explanatory purposes.

Referring to FIGS. 8-11 collectively, the connector assembly 100 may include a device that does not accommodate pins of the second substrate 206. As such, the overall arrangement does not include pins, such as screw-mount pins 118, 121 (FIG. 1). Thus, the housing 103 does not include a pin receptacle portion 151. However, the connector assembly 100 of FIGS. 8-11 may still accommodate movement along the Y axis (e.g., in the vertical direction).

According to various embodiments, a method is described for coupling substrates 203, 206 using the connector assembly 100 of FIG. 1 or FIG. 8. The method includes providing a bottom substrate (e.g., the second substrate 206), where the bottom substrate has a plurality of pins, such as a first screw-mount pin 118 and a second screw-mount pin 121 oriented in a vertical direction. The bottom substrate can further include a bottom substrate socket, such as substrate socket 212.

The method further includes providing the connector assembly of FIG. 1 or FIG. 8. For instance, the connector assembly 100 can include a housing 103 having cabling 109 stored therein, a first socket (e.g., first blind-mate interface socket 112), and a second socket (e.g., second blind-mate interface socket 115). In some embodiments, the housing 103 includes a plurality of pin receptacle portions 151, and the first socket and the second socket each include at least one spring plunger that permits movement in a vertical direction to accommodate variable distances between the first substrate and the second substrate.

The method further includes positioning the pins in the pin receptacle portions 151 of the housing 103, where the housing 103 comprises a plurality of floats (not shown) that permit the pins to move in a horizontal direction. Moreover, the method includes coupling the first socket of the connector assembly 100 to the bottom substrate socket of the bottom substrate, and positioning a top substrate (e.g., first substrate 203) on top of the housing 103 to couple the second socket of the connector assembly 100 to a top substrate socket of the top substrate.

While various embodiments of the connector assembly 100 have been shown and described, it is understood that, in alternative implementations, the connector assembly 100 can be modified without deviating from the aspects of the present disclosure to accommodate more than two substrates, allowing for the connection of multiple stacked PCBs or other substrates. For example, the housing 103 of the connector assembly 100 can be formed of different materials, such as metal or ceramic, to provide additional properties, such as increased strength or heat resistance. The cabling 109 stored within the housing 103 could be of different types, such as coaxial cables, twisted pair cables, or optical fibers, to accommodate different signal transmission requirements.

The spring plungers 146, 147 in the sockets could be replaced with other types of spring-loaded mechanisms, such as leaf springs or torsion springs, to provide the same vertical movement capability. The pin receptacle portions 151 in the housing 103 can be selected to accommodate different types of pins, such as bayonet pins or push-pull pins, in addition to screw-mount pins 118, 121. The floats in the housing 103 can be selected to permit movement in other directions, such as rotational movement, in addition to horizontal movement. The connector assembly 100 can be configured to be mated horizontally or at an angle, in addition to vertically, to the substrates 203, 206. The connector assembly 100 can include additional features, such as electromagnetic shielding or vibration damping, to improve its performance in specific applications.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A system, comprising:
a first substrate, a second substrate having a first pin and a second pin, and a connector assembly configured to couple the first substrate to the second substrate, wherein the connector assembly comprises:
a housing comprising a first connector housing portion and a second connector housing portion adapted to detachably attach to one another and retain cabling therein, wherein the first connector housing portion and the second connector housing portion each comprises a pin receptacle portion configured to receive the first pin and the second pin, respectively; and
a first socket configured to couple the cabling to the first substrate, and a second socket configured to couple the cabling to the second substrate, the first socket and the second socket comprising at least one spring plunger that permits movement in a vertical direction.

2. The system according to claim 1, further comprising:
a first cap and a first cap base configured to receive a distal end of the first pin and connect the first pin to the first substrate, the first cap comprising a float that permits movement in a horizontal direction; and
a second cap and a second cap base configured to receive a distal end of the second pin and connect the second pin to the first substrate, the second cap comprising a float that permits movement in a horizontal direction.

3. The system according to claim 2, wherein the first pin is a first screw-mount pin forming a threaded connection with the second substrate, and the second pin is a second screw-mount pin forming a threaded connection with the second substrate.

4. The system according to claim 1, wherein the first socket is a first blind-mate socket configured to couple to a substrate socket of the first substrate, and the second socket is a second blind-mate socket configured to couple to a substrate socket of the second substrate.

5. The system according to claim 1, wherein at least one of the first connector housing portion and the second connector housing portion comprises a plurality of cabling projections defining a plurality of apertures that extend through an entirety of the housing.

6. The system according to claim 5, wherein the cabling is routed through the plurality of cabling projections such that the cabling forms a plurality of S-shaped sections.

7. The system according to claim 1, wherein the first connector housing portion comprises a projection integral therewith configured to extend into an aperture of the second substrate.

8. The system according to claim 1, wherein the second connector housing portion comprises a plurality of tabs configured to engage with corresponding projections of the first connector housing, and the first connector housing comprises a plurality of tab recesses configured to receive and retain corresponding ones of the plurality of tabs.

9. A board-to-board connector assembly, comprising:
a housing having cabling stored therein, the housing configured to be positioned between a first substrate and a second substrate; and
a first socket configured to couple the cabling to the first substrate, and a second socket configured to couple the cabling to the second substrate, the first socket and the second socket each comprising at least one spring plunger that permits movement in a vertical direction to accommodate variable distances between the first substrate and the second substrate.

10. The board-board connector assembly according to claim 9, wherein the housing comprises a first connector housing portion and a second connector housing portion detachably attachable to one another.

11. The board-board connector assembly according to claim 10, wherein the first connector housing portion and the second connector housing portion each comprises a pin receptacle portion configured to receive a first pin coupled to the second substrate and a second pin coupled to the second substrate, respectively.

12. The board-board connector assembly according to claim 11, further comprising:
a first cap and a first cap base configured to receive a distal end of the first pin and connect the first pin to the first substrate, the first cap comprising a float that permits movement in a horizontal direction; and
a second cap and a second cap base configured to receive a distal end of the second pin and connect the second pin to the first substrate, the second cap comprising a float that permits movement in a horizontal direction.

13. The board-board connector assembly according to claim 12, wherein the first pin is a first screw-mount pin forming a threaded connection with the second substrate, and the second pin is a second screw-mount pin forming a threaded connection with the second substrate.

14. The board-board connector assembly according to claim 9, wherein the first socket is a first blind-mate socket configured to couple to a substrate socket of the first substrate, and the second socket is a second blind-mate socket configured to couple to a substrate socket of the second substrate.

15. The board-board connector assembly according to claim 10, wherein at least one of the first connector housing portion and the second connector housing portion comprises a plurality of cabling projections defining a plurality of apertures that extend through an entirety of the housing.

16. The board-board connector assembly according to claim 15, wherein the cabling is routed through the plurality of cabling projections such that the cabling forms a plurality of S-shaped sections.

17. The board-board connector assembly according to claim 10, wherein the first connector housing portion comprises a projection integral therewith configured to extend into an aperture of the second substrate.

18. A board-to-board connector assembly, comprising:
a housing having cabling stored therein that is configured to be positioned between a first substrate and a second substrate, the housing comprising a plurality of pin receptacle portions configured to receive a first pin coupled to the second substrate and a second pin coupled to the second substrate, respectively, the housing comprising a plurality of floats that permits the first pin and the second pin to move in a horizontal direction; and
a first socket configured to couple the cabling to the first substrate, and a second socket configured to couple the cabling to the second substrate, the first socket and the second socket each comprising at least one spring plunger that permits movement in a vertical direction to accommodate variable distances between the first substrate and the second substrate.

19. The board-board connector assembly according to claim 18, wherein the housing comprises a first connector housing portion and a second connector housing portion detachably attachable to one another, wherein the plurality of pin receptacle portions are integral with the first connector housing portion.

20. The board-board connector assembly according to claim 19, wherein the floats comprise a first float and a second float, and the board-to-board connector assembly further comprises:
a first cap and a first cap base configured to receive a distal end of the first pin and connect the first pin to the first substrate, the first cap comprising the first float that permits movement in a horizontal direction; and
a second cap and a second cap base configured to receive a distal end of the second pin and connect the second pin to the first substrate, the second cap comprising the second float that permits movement in a horizontal direction.

21. The board-board connector assembly according to claim 18, wherein the first pin is a first screw-mount pin forming a threaded connection with the second substrate, and the second pin is a second screw-mount pin forming a threaded connection with the second substrate.

22. The board-board connector assembly according to claim 18, wherein the first socket is a first blind-mate socket configured to couple to a substrate socket of the first substrate, and the second socket is a second blind-mate socket configured to couple to a substrate socket of the second substrate.

23. The board-board connector assembly according to claim 18, wherein at least one of the first connector housing portion and the second connector housing portion comprises a plurality of cabling projections defining a plurality of apertures that extend through an entirety of the housing, wherein the cabling is routed around the plurality of cabling projections.

24. The board-board connector assembly according to claim 23, wherein the cabling is routed through the plurality of cabling projections such that the cabling forms a plurality of S-shaped sections.

25. The board-board connector assembly according to claim 19, wherein the first connector housing portion comprises a projection integral therewith configured to extend into an aperture of the second substrate.

26. The board-board connector assembly according to claim 19, wherein the second connector housing portion comprises a plurality of tabs configured to engage with corresponding projections of the first connector housing, and the first connector housing comprises a plurality of tab recesses configured to receive and retain corresponding ones of the plurality of tabs.

27. A method for coupling substrates, comprising:
providing a bottom substrate comprising a plurality of pins oriented in a vertical direction and a bottom substrate socket;
providing a board-to-board connector assembly, comprising: a housing having cabling stored therein, a first socket, and a second socket, the housing comprising a plurality of pin receptacle portions, the first socket and the second socket each comprising at least one spring plunger that permits movement in a vertical direction to accommodate variable distances between the first substrate and the second substrate;
positioning the plurality of pins in the pin receptacle portions of the housing, wherein the housing comprises a plurality of floats that permit the plurality of pins to move in a horizontal direction;
coupling the first socket of the board-to-board connector assembly to the bottom substrate socket of the bottom substrate; and
positioning a top substrate on top of the housing to couple the second socket of the board-to-board connector assembly to a top substrate socket of the top substrate.

28. The method according to claim 27, wherein the top substrate and the bottom substrate are each a printed circuit board (PCB).
